(19) United States
(12) Patent Application Publication
(10) Pub. No.: US 2011/0091851 A1
(43) Pub. Date: Apr. 21, 2011

(54) MULTI-PURPOSE SOLITAIRE / REHABILITATION / EDUCATION TOOL FOR ASSISTING PATIENTS / STUDENTS / USERS TO IMPROVE MEMORY AND EYE / HAND COORDINATION

(76) Inventor: Joseph F. Aniano, Oceanside, NY (US)

(21) Appl. No.: 12/774,204

(22) Filed: May 5, 2010

Related U.S. Application Data
(60) Provisional application No. 61/253,003, filed on Oct. 19, 2009.

(51) Int. Cl. G09B 19/00

(52) U.S. Cl. 434/259

(57) ABSTRACT

A multi-purpose tool may be used for assisting patients, students and/or users to improve memory and eye/hand coordination. The tool may be used for a number of functions, including solitaire games, rehabilitation or education. The tool may be in the form of a board having a slot in an upper frame member. Below the upper frame member may be seven spaces, and below the seven spaces may be vertical dividers.

### CROSS-REFERENCE TO RELATED APPLICATIONS

This application claims the benefit of U.S. Provisional patent application 61/253,003, filed Oct. 19, 2009, herein incorporated by reference.

### BACKGROUND OF THE INVENTION

The present invention relates to a memory and coordination tool and, more particularly, to a multi-purpose solitaire, rehabilitation, and/or education tool for assisting patients, students, and/or users to improve their memory and eye/hand coordination.

Various tools are marketed as educational devices or rehabilitation tools. Often, a rehabilitation center may need multiple devices for various types of occupational or physical therapy. Patients recovering from a traumatic brain injury may require a different type of rehabilitation tool while users suffering from motor related diseases, such as Parkinson's disease, may require a different type of tool.

As can be seen, there is a need for tool that may be used by various types of users in various environments.

### SUMMARY OF THE INVENTION

In one aspect of the present invention, a tool comprises a flat board; an upper frame member spanning the top of the board; a slot cut into the upper frame member, the slot adapted to hold a card therein; side members spanning the sides of the board; a plurality of vertical dividers, the vertical dividers dividing the board into a plurality of columns.

In another aspect of the present invention, a kit comprises a tool comprising a flat board; an upper frame member spanning the top of the board; a slot cut into the upper frame member, the slot adapted to hold a card therein; side members spanning the sides of the board; a plurality of vertical dividers, the vertical dividers dividing the board into a plurality of columns; and at least one set of cards.

These and other features, aspects and advantages of the present invention will become better understood with reference to the following drawings, description and claims.

### BRIEF DESCRIPTION OF THE DRAWINGS

FIG. 1 is a right side view of a tool according to an embodiment of the present invention;

FIG. 2 is a top view of the tool of FIG. 1; and

FIG. 3 is a bottom end view of the tool of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a multi- purpose tool for assisting patients, students and/or users to improve memory and eye/hand coordination. The tool may be used for a number of functions, including solitaire games, rehabilitation or education. The tool may be in the form of a board having a slot in an upper frame member. As discussed in greater detail below, below the upper frame member may be seven spaces, and below the seven spaces may be vertical dividers.

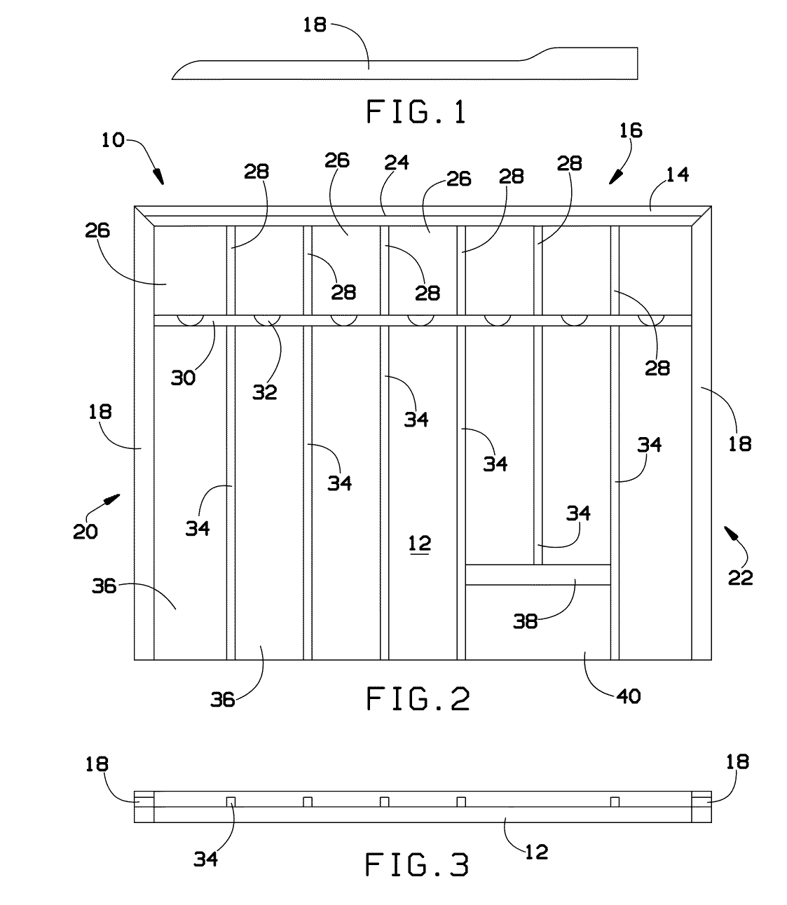

Referring to FIGS. 1 through 3, there is shown an embodiment of the tool 10 of the present invention. The tool 10 include a board 12 having an upper frame member 14 attached to a top end 16 of the board 12. Side members 18 may be attached to left and right sides 20, 22 of the board 12. The board 12 may be, for example, made of wood, plastic, or the like. In one embodiment, the board 12 may be made of 1/2 inch wood. The board 12 may be from about 14 to about 30 inches wide, typically about 20 to about 24 inches wide. In one embodiment, the board 12 may be about 21 1/2 inches wide. The board 12 may be from about 12 to about 22 inches deep, typically from about 16 to about 20 inches deep. In one embodiment, the board 12 may be about 18 inches deep. The upper frame member 14 may be the same length as the width of the board 12. The upper frame member 14 may be about 1.25 inches deep and about 3/4 inch wide. The side members 18 may be designed similar to the upper frame member 14, having a length that may be about the same depth of the board 12, a depth of about 1.25 inches, and a width of about 3/4 inch. The tool 10 may be covered in felt or canvas, for example, or the tool 10 may be painted or stained. Lettering can be affixed to the tool 10 to indicate the nature of the use of the board.

The upper frame member 14 may include a horizontal slot 24. The horizontal slot 24 may be used in one embodiment of the present invention, to hold flash cards in a vertical position so that the patient/students can see/read the cards and place them on the board as directed by the therapist/instructor. The horizontal slot 24 may be cut in the upper frame member 14 at an angle to support the flashcards at an appropriate angle to allow ease of viewing for the patient/students.

Below the upper frame member 14 may be formed a plurality of spaces 26. The spaces 26 may be for storing used flash cards or for placements of suits in a solitaire game. In one embodiment of the invention, seven spaces 26 may be formed by attaching a plurality of upper vertical dividers 28. The vertical dividers 28 may be six vertical dividers to provide seven spaces 26. The vertical dividers 28 may be places substantially equidistant from each other to provide spaces 26 of the same size. Lower ends of the upper vertical dividers 28 may attach to a long horizontal divider 30. The long horizontal divider 30 may run between the sides 18. The long horizontal divider 30 may have indentations 32 cut to correspond to a central location of each of the spaces 26. The indentations 32 may help place and remove cards from each of the spaces 26.

Below the long horizontal divider 30, a plurality of lower vertical dividers 34 may divide a lower portion of the board into columns 36. In one embodiment, six lower vertical dividers 34 may divide the lower portion of the board into seven columns 36. In one embodiment, the columns 36 may be aligned vertically with each of the spaces 26. The columns 36 may be used for placement of flashcards or for playing solitaire, for example.

At least one column 36, typically two adjacent columns 36 may be blocked off with a short horizontal divider 38. A space 40 provided below the short horizontal divider 38 may be used for placement of playing cards, flash cards or the like, for example.

A kit, according to an embodiment of the present invention, may include the tool 10, as described above, along with one or more sets of cards, such as a standard deck of playing cards or one or more sets of flash cards. The flash card sets may include 26 cards with individual letters of the alphabet. In this embodiment, a therapist may place the letters, seven at a time, in the slot 24 of the tool 10. The student/patient may have a set of cards showing pictures of items representing letters of the alphabet. The student/patient may place the picture cards in the corresponding space 26 below the cards in the horizontal slot 24.

In another embodiment, the therapist/instructor may have a set of seven cards showing the primary colors and the name of the colors which may be placed in the horizontal slot 24. The patient/student may be given a set of cards showing different items corresponding to one of the seven color cards. The patient/student may place the appropriately colored card in the space 26 below the color card.

In another embodiment, the therapist/instructor may have a set of 14 cards (numbered 2-15). Seven of these cards may be placed, at random, in the horizontal slot 24 on the tool 10. The patient/therapist may have a set of 49 cards, for example, that may be placed faced down in the seven long vertical columns 36. These cards may have math problems, the answers to which may be represented on the cards in the horizontal slot 24. The patient/student may turn over a card in the first column 36. If this card shows a problem corresponding to one of the answers indicated on one of the cards in the horizontal slot 24, the card may be placed in the space below the answer card. If there is no answer in the horizontal slot 24, the card may be placed in the space 40. The patient/student may continue to turn cards over in each column 36. Once all 49 cards have been considered, the other seven answer cards may be placed in the horizontal slot 24 and the patient/student may proceed as above to answer the remaining math questions.

The tool 10 may also be used as a solitaire board, with four of the seven spaces 26 at the top to place the four Aces as they come up in playing the game. The seven columns 36 may be used to place cards as they are dealt out. The space 40 at the bottom of the board may hold the deck of cards during play. By having divided columns 36, the tool 10 may be helpful for persons with motor disabilities or diseases to play solitaire and keep the cards organized.

It should be understood, of course, that the foregoing relates to exemplary embodiments of the invention and that modifications may be made without departing from the spirit and scope of the invention as set forth in the following claims.

We claim:

1. A tool comprising:
a board;
an upper frame member spanning the top of the board;
a slot cut into the upper frame member, the slot adapted to hold a card therein;
side members spanning the sides of the board;
a plurality of vertical dividers, the vertical dividers dividing the board into a plurality of columns.

2. The tool of claim 1, further comprising a first horizontal divider, the horizontal divider separating the columns into a plurality of spaces above each of the plurality of columns.

3. The tool of claim 1, further comprising a second horizontal divider, the second horizontal divider forming a space from a bottom portion of at least one of the plurality of columns.

4. The tool of claim 3, wherein the second horizontal divider may be formed from the bottom portion of two columns.

5. The tool of claim 1, further comprising a plurality of indications formed in the first horizontal divider, each of the plurality of indications corresponding to each of the plurality of spaces.

6. The tool of claim 1, wherein the plurality of columns is seven columns.

7. A kit comprising:
a tool comprising:
a flat board;
an upper frame member spanning the top of the board;
a slot cut into the upper frame member, the slot adapted to hold a card therein;
side members spanning the sides of the board;
a plurality of vertical dividers, the vertical dividers dividing the board into a plurality of columns; and
at least one set of cards.

8. The kit of claim 7, wherein the at least one set of cards includes a set of playing cards.

9. The kit of claim 7, wherein the at least one set of cards includes at least one set of flash cards.

10. The kit of claim 9, wherein the at least one set of flash cards is a set of flash cards selected from the group consisting of alphabet cards, color cards and numerical cards.
